(19) United States
(12) Patent Application Publication
(10) Pub. No.: US 2010/0102094 A1
(43) Pub. Date: Apr. 29, 2010

(54) PACKAGE WITH FLUID-DISPENSER SYSTEM

(75) Inventors: Chad E. Rice, Lititz, PA (US); W. Gordon Beecroft, Leola, PA (US)

Correspondence Address: BARNES & THORNBURG LLP, 11 SOUTH MERIDIAN, INDIANAPOLIS, IN, 46204, US

(73) Assignee: BERRY PLASTICS CORPORATION, Evansville, IN (US)

(21) Appl. No.: 12/606,847

(22) Filed: Oct. 27, 2009

Related U.S. Application Data
(60) Provisional application No. 61/109,128, filed on Oct. 28, 2008.

(51) Int. Cl. B67D 3/00

(52) U.S. Cl. 222/562; 222/544; 222/566

(57) ABSTRACT

A package includes a container and a removable cap coupled to a filler neck of the container. The package also includes a fluid dispenser coupled to the filler neck to regulate discharge of fluid material from an interior region of the container.

This application claims priority under 35 U.S.C. §119(e) to U.S. Provisional Application Ser. No. 61/109,128, filed Oct. 28, 2008, which is expressly incorporated by reference herein.

### BACKGROUND

The present disclosure relates to a package for storing fluid materials an, in particular, to a package having a fluid-dispenser system. More particularly, the present disclosure relates to a package including a container and a fluid dispenser for dispensing a fluid material from the container.

### SUMMARY

A package in accordance with the present disclosure is configured to store and dispense fluid materials. The package includes a container and a removable cap for closing an opening into the container.

In illustrative embodiments, the package also includes a fluid dispenser coupled to the container and configured to dispense fluid material extant in an interior region formed in the container. The fluid dispenser includes a pour spout and a separate syringe receiver and these are exposed upon movement of the cap relative to the container to an opened position. A user has the option to dispense dry or liquid fluid material from the container either by tipping the container to pour fluid material through the pour spout or by drawing fluid material from the container into a syringe coupled to the syringe receiver.

In an illustrative embodiment, the fluid dispenser includes a closure. The closure includes a base adapted to mate with a container to occlude an opening into an interior region formed in the container and formed to include separate first and second fluid-discharge apertures. The syringe receiver is coupled to the base at the first fluid-discharge aperture and configured to receive a fluid-transfer tip of a syringe to expose the fluid-transfer tip to fluid material extant in the interior region of the container via the first fluid-discharge aperture. The pour spout is coupled to the base at the second fluid-discharge aperture.

In an illustrative embodiment, the fluid dispenser also includes a fluid-transfer conduit associated with the syringe receiver and arranged to extend downwardly into the interior region formed in the container. The fluid-transfer conduit is coupled to an underside of the base at the first fluid-discharge aperture to communicate with the syringe receiver. The fluid-transfer conduit is curved and configured to include a concave surface arranged to face upwardly toward the pour spout.

Additional features of the present disclosure will become apparent to those skilled in the art upon consideration of illustrative embodiments exemplifying the best mode of carrying out the disclosure as presently perceived.

### BRIEF DESCRIPTION OF THE DRAWINGS

The detailed description particularly refers to the accompanying figures in which:

FIG. 1 is a perspective view of a package in accordance with the present disclosure showing a transparent container formed to include a filler neck extending upwardly from a fluid-storage body and providing a filler-neck passageway opening into an interior region of the fluid-storage body, a fluid dispenser mounted in the filler neck and arranged to extend downwardly into the interior region formed in the fluid-storage body to reach a fluid material stored in the interior region, and a removable cap separated from the filler neck to expose a pour spout and a syringe receiver formed in the fluid dispenser and showing that the syringe receiver is arranged to lie alongside the pour spout and configured to receive a fluid-transfer tip of a syringe therein as suggested in FIGS. 3, 6, and 7 to facilitate transfer of a fluid material extant in the interior region of the fluid-storage body into the syringe after removal of the removable cap from the filler neck;

FIG. 2 is an exploded perspective assembly view of the package of FIG. 1 along with a syringe for removing a fluid material contained in the package and showing an illustrative container, fluid dispenser, and cap included in the package;

FIG. 3 is a reduced-size view of the container of FIG. 1 showing insertion of a syringe into a syringe receiver formed in a closure included in the fluid dispenser and configured to mate with the filler neck to regulate discharge of fluid material from the interior region of the fluid-storage body in the container through the filler neck;

FIG. 4 is a reduced-size sectional view taken along line 4-4 of FIG. 1 showing the fluid dispenser before the syringe is inserted into the syringe receiver formed in the closure included in the fluid dispenser;

FIG. 5 is an enlarged view of a portion of the container and fluid dispenser shown in section in FIG. 4 showing portions of the syringe receiver (on the left) and the pour spout (on the right) in greater detail;

FIG. 6 is an enlarged sectional view of the container, fluid dispenser, and syringe taken along line 6-6 of FIG. 3 showing that the syringe includes a plunger movable in a stationary tube relative to an inlet/outlet orifice formed in a fluid-transfer tip provided at a lower end of the stationary tube;

FIG. 7 is a sectional view similar to FIG. 6 showing upward movement of the plunger relative to the stationary tube to draw fluid material from the interior region of the fluid-storage body into a chamber formed in the stationary tube included in the syringe through the fluid-transfer channel and the syringe receiver;

FIG. 8 is a perspective view of the top side of the fluid dispenser of FIGS. 1-5 showing a large-diameter pour spout and a small-diameter syringe receiver formed in the closure and showing a curved fluid-transfer conduit coupled in fluid communication to the small-diameter syringe receiver;

FIG. 9 is a perspective view of the underside of the fluid dispenser of FIG. 6 showing that the fluid-transfer conduit is arranged to extend downwardly from the underside of the closure and configured to terminate at an open inlet;

FIG. 10 is an enlarged sectional view of the fluid dispenser taken along line 10-10 of FIG. 8;

FIG. 11 is a partial sectional view of the filler neck taken along line 11-11 of FIG. 2 showing an annular ledge formed along a cylindrical interior wall of the filler neck and configured to mate with a radially outwardly extending annular mount rim included in a perimeter edge of the closure as suggested in FIGS. 4 and 5 to support the closure of the fluid dispenser in the passageway formed in the filler neck; and

FIG. 12 is a sectional view similar to FIG. 6 (with the fluid-transfer conduit omitted) in accordance with another embodiment of the present disclosure.

### DETAILED DESCRIPTION

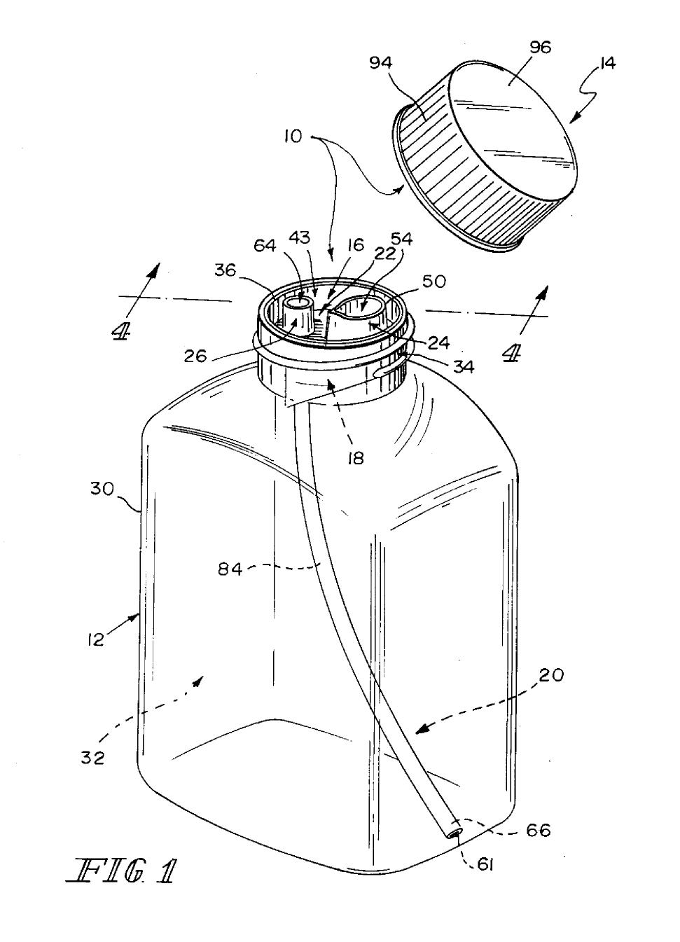

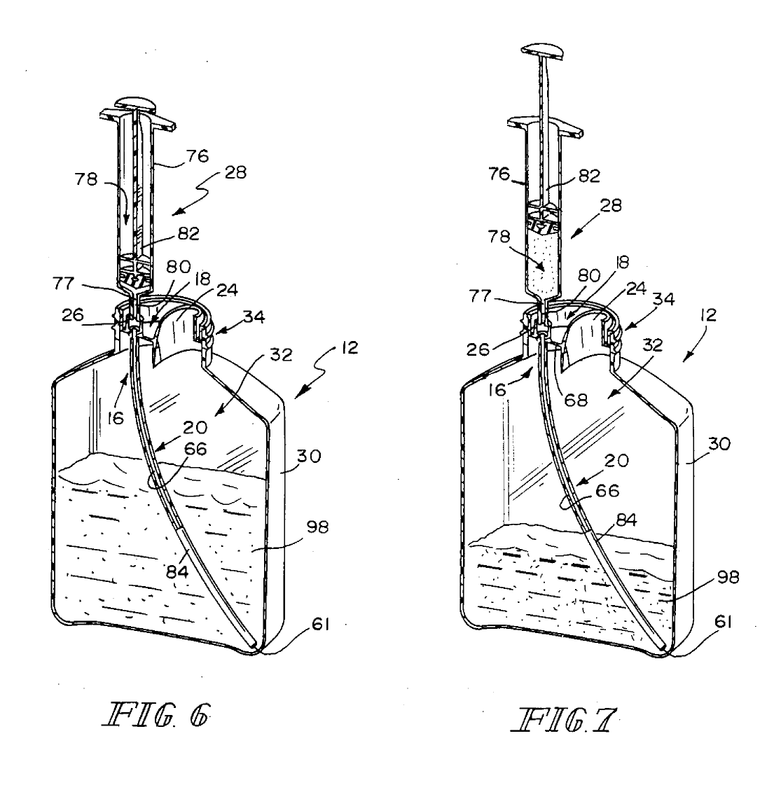

A package 10 in accordance with the present disclosure includes a container 12, a removable cap 14, and a fluid dispenser 16 including a closure 18 and a fluid-transfer conduit 20 coupled to closure 18 as suggested in FIGS. 1, 2, and 4. Closure 18 includes a base 22, a pour spout 24 coupled to base 22, and a syringe receiver 26 coupled to base 22 as suggested in FIGS. 1, 2, 4, and 6-8. A user can elect to dispense fluid material from container 12 using either pour spout 24 or a syringe 28 inserted into syringe receiver 26. Syringe receiver 26 is adapted to mate with a syringe 28 as suggested in FIGS. 2-5 to allow a user to transfer fluid material 98 from container 12 into syringe 28 through fluid-transfer conduit 20 and syringe receiver 26 as suggested in FIGS. 6 and 7.

Container 12 includes a fluid-storage body 30 formed to include an interior region 32 and a filler neck 34 having a mouth 36 opening into a filler-neck passageway 38 communicating with interior region 32 as shown, for example, in FIGS. 1, 4, and 11. Filler neck 34 is coupled to fluid-storage body 30 as suggested in FIGS. 1 and 2. It is within the scope of this disclosure to store dry or liquid fluid material 98 in interior region 32 of fluid-storage body 30 and use fluid dispenser 16 to dispense such dry or liquid fluid material 98 from fluid-storage body 30. Cap 14 is configured to mate with filler neck 34 using any suitable means to close open mouth 36 while closure 18 of fluid dispenser 16 is retained in filler neck 34 and fluid-transfer conduit 20 is located in interior region 32 of fluid-storage body 30. It is within the scope of this disclosure to vary the length of filler neck 34 or omit the filler neck and mount closure 18 in an opening formed in a container.

In an illustrative embodiment, fluid dispenser 16 includes a closure 18 sized to be located and retained in filler-neck passageway 38 formed in filler neck 34 as suggested in FIGS. 2-5. Fluid dispenser 16 also includes a fluid-transfer conduit 20 resembling a curved soda straw in an illustrative embodiment as suggested in FIG. 2. Fluid-transfer conduit 20 is formed to include a conduit passageway 66 for conducting fluid material 98 from interior region 32 of fluid-storage body 30 to syringe 28 as suggested in FIG. 7. Fluid-transfer conduit 20 also is formed to include an inlet 61 opening into conduit passageway 66 as suggested in FIGS. 7 and 9.

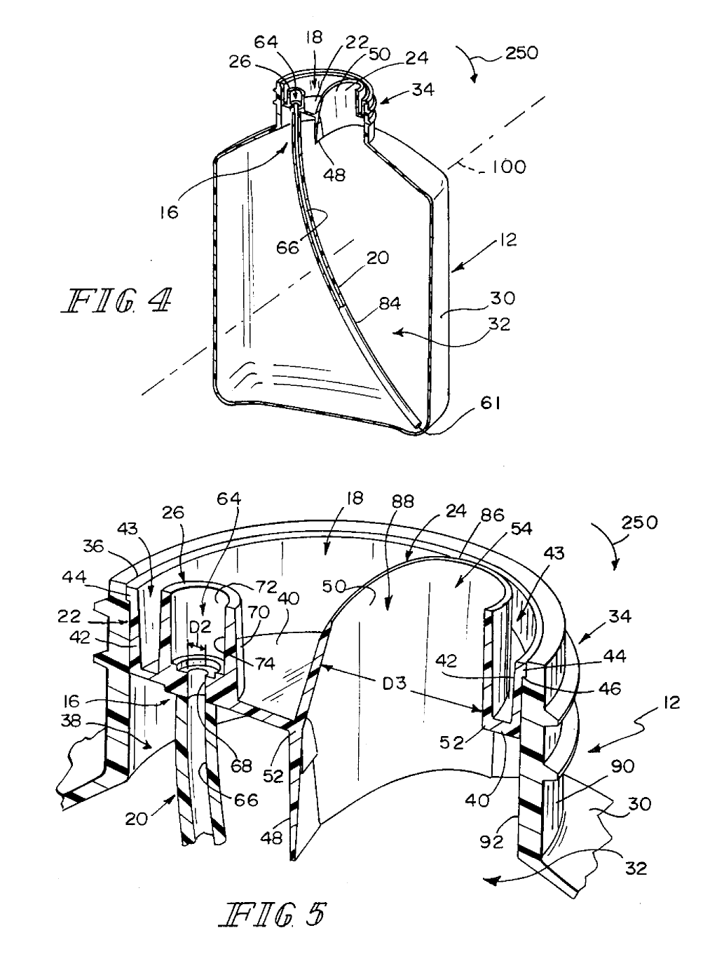

Closure 18 includes a base 22 that is configured to mate with filler neck 34 to retain closure 18 in filler-neck passageway 38 as shown, for example, in FIG. 5. In an illustrative embodiment shown in FIG. 5, base 22 includes a round plate 40 coupled to pour spout 24 and syringe receiver 26, an annular side wall 42 extending upwardly from a perimeter edge of round plate 40 and cooperating with round plate 40 to form an upwardly opening basin 43, and a radially outwardly extending annular mount rim 44 coupled to an upper perimeter edge of annular side wall 42. An annular downwardly facing surface provided on radially outwardly extending annular mount rim 44 of closure 18 is sized to mate with an annular upwardly facing surface provided on an annular ledge 46 included in filler neck 34 and located in filler-neck passageway 38 as suggested in FIGS. 2, 5, and 11.

Pour spout 24 of fluid dispenser 16 is coupled to base 22 as suggested in FIGS. 4 and 5. Pour spout 24 is formed to define a second discharge-port means 54 for discharging fluid material extant in interior region 32 of fluid-storage body 30 while closure 18 is coupled to filler neck 34 and after cap 14 has been separated from filler neck 34. Dry or liquid fluid material 98 can be discharged from fluid-storage body 30 via pour spout 24 simply by tipping container 12 about a tipping axis 100 in clockwise direction 250 after removal of cap 14 from filler neck 34 as suggested in FIGS. 4 and 5.

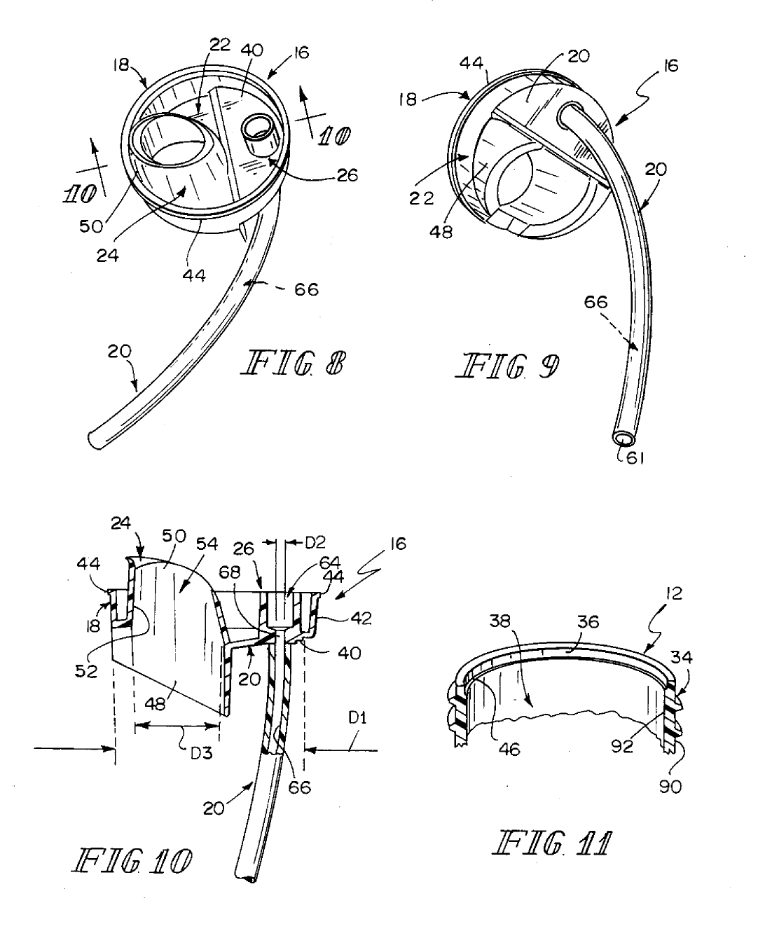

In the illustrated embodiment, pour spout 24 includes an intake tube 48 and an outflow tube 50 as shown in FIG. 5. Intake tube 48 is coupled to round plate 40 at and in alignment with a second fluid-discharge aperture 52 formed in round plate 40 and arranged to extend downwardly through passageway 38 into interior region 32 as suggested in FIG. 5. Outflow tube 50 is coupled to round plate 40 at and in alignment with second fluid-discharge aperture 52 and arranged to extend upwardly through filler-neck passageway 38 and out of filler-neck passageway 38 through open mouth 36 of filler neck 34 as suggested in FIGS. 5 and 10.

Syringe receiver 26 of fluid dispenser 16 is coupled to base 22 and arranged to lie in spaced-apart, side-by-side relation to pour spout 24 as suggested in FIGS. 4, 5, and 10. Syringe receiver 26 is formed to define a first discharge-port means 64 for receiving a fluid-transfer tip 77 of syringe 28 to allow flow of fluid material from interior region 32 of fluid-storage body 30 into syringe 28 first through an inlet 61 and a conduit passageway 66 formed in fluid-transfer conduit 20 and then through a receiver passageway (first fluid-discharge aperture) 68 formed in syringe receiver 26 and arranged to lie in fluid communication with conduit passageway 66 as suggested in FIG. 7. Dry or liquid fluid material 98 can be discharged from fluid-storage body 30 via syringe receiver 26 by using syringe 28 in the manner shown, for example, in FIGS. 6 and 7.

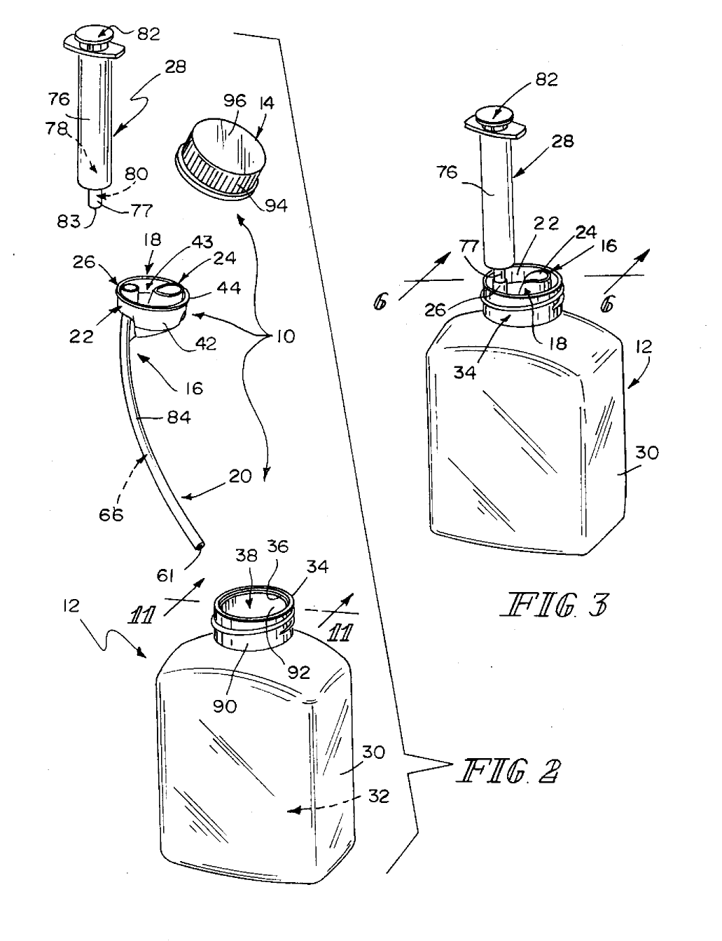

In the illustrated embodiment, syringe receiver 26 is defined by an upstanding tubular sleeve 70 defining a mouth 72 opening into a sleeve passageway 74 arranged to lie in fluid communication with receiver passageway 68. Sleeve passageway 74 is sized to receive fluid-transfer tip 77 of syringe 28 therein as suggested in FIGS. 3, 6, and 7. Tubular sleeve 70 is coupled to round plate 40 as shown, for example, in FIG. 5.

Syringe 28 includes a tube (barrel) 76 formed to include a fluid-storage chamber 78 and a fluid-transfer tip 77 coupled to a lower end of tube 76 to cause a tip passageway 80 formed in fluid-transfer tip 77 to lie in fluid communication with fluid-storage chamber 78 as suggested in FIG. 7. Fluid-transfer tip 77 also is formed to include an inlet-outlet orifice 83 opening into tip passageway 80 as suggested in FIGS. 2, 6, and 7. Syringe 28 also includes a plunger 82 mounted for movement in fluid-storage chamber 78 relative to tube 76 to generate a suction force sufficient to draw fluid material 98 from interior region 32 into fluid-storage chamber 78 via inlet 61, conduit passageway 66, receiver passageway 68, sleeve passageway 74, and tip passageway 80 as suggested in FIGS. 6 and 7.

In use, a user has the option to dispense dry or liquid fluid material from container 12 either by (1) tipping the container about tipping axis 100 in clockwise direction 250 (see FIG. 4) to cause fluid material 98 to flow out of interior region 32 of fluid-storage body 30 through pour spout 24 or (2) drawing fluid material from interior region 32 of the fluid-storage body into a fluid-storage chamber 78 in syringe 28 while syringe 28 is coupled to syringe receiver 26 included in fluid dispenser 16 as suggested in FIG. 7. Once cap 14 is removed from filler neck 34, both pour spout 24 and syringe receiver 26 are exposed. Pour spout 24 and syringe receiver 26 are oriented in illustrative embodiments to allow fluid material 98 to be discharged through pour spout 24 without being discharged through syringe receiver 26.

Package 10 is well-suited for use in the prescription drug market, pharmaceutical market, off-the-shelf medication market, and over-the-counter medication market. Fluid dispenser 16 can be used to dispense both dry and liquid fluid medicines. It is expected that consumers would like the option to use an oral syringe for babies, toddler, etc., in addition to a non-drip pour spout which could be used with a spoon.

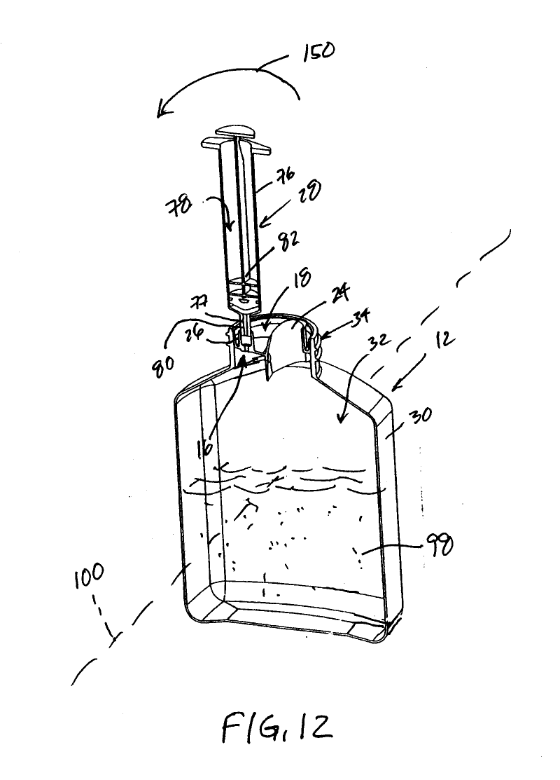

It is within the scope of this disclosure to omit fluid-transfer conduit 20 from fluid dispenser 16 as suggested in FIG. 12. In such an embodiment, a user would tip container 12 about tipping axis 100 in counterclockwise direction 150 (see FIG. 12) to cause fluid material in interior region 32 of fluid-storage body 30 to reach or move nearer to syringe receiver 26. Such tipping in counterclockwise direction 150 causes fluid material to communicate with a syringe 28 coupled to syringe receiver 26 so that fluid material 98 extant in interior region 32 of fluid-storage body 30 can be drawn into syringe 28.

It is also within the scope of this disclosure to provide a package including a container 12 and a filler neck cover (not shown) comprising a base mounted on the container filler neck, a flip-top cap, and a hinge for supporting the flip-top cap from a closed position covering and mating with the base and an opened position uncovering and exposing the base. In such an embodiment, the base of the filler neck cover includes closure 18 comprising base 22, pour spout 24, and syringe receiver 26.

A package 10 in accordance with the present disclosure includes a container 12, removable cap 14, and a fluid dispenser 16 as shown in FIGS. 1 and 2. Container 12 includes a fluid-storage body 30 formed to include an interior region 32 and a filler neck 34 having a mouth 36 opening into a filler-neck passageway 38 formed in filler neck 34. Filler neck 34 is arranged to communicate with interior region 32 of fluid-storage body 30 as suggested in FIG. 2. Removable cap 14 is configured to mount on filler neck 34 to close mouth 36 of filler neck 34 as suggested in FIG. 1. Fluid dispenser 16 includes a closure 18 coupled to filler neck 34 and arranged to communicate with and close filler-neck passageway 38 as suggested in FIGS. 1-3. In some embodiments, fluid dispenser 16 also includes a fluid-transfer conduit 20 arranged to extend from closure 18 into interior region 32 of fluid-storage body 30 to communicate with fluid material 98 stored therein as suggested in FIGS. 6 and 7.

Closure 18 includes a base 22, a pour spout 24, and a syringe receiver 26 as suggested in FIGS. 1 and 2. Base 22 is arranged to mate with filler neck 34 to close mouth 36 opening into filler-neck passageway 38 and formed to include separate first and second fluid-discharge apertures 68, 52 as shown, for example, in FIG. 5.

Fluid-transfer conduit 20 is formed to include a conduit passageway 66 as suggested in FIGS. 1, 2, and 5. Fluid-transfer conduit 20 is coupled to base 22 at first fluid-discharge aperture 68 to place conduit passageway 66 in fluid communication with first fluid-discharge aperture 68 as shown, for example, in FIG. 5.

Syringe receiver 26 is coupled to base 22 at first fluid-discharge aperture 68 as suggested in FIG. 5. Syringe receiver 26 is configured to define first discharge-port means for receiving a fluid-transfer tip 77 of a syringe 28 to allow flow of fluid material 98 from interior region 32 of fluid-storage body 30 into syringe 28 through conduit passageway 66 and through first fluid-discharge aperture 68 as suggested in FIGS. 6 and 7.

Pour spout 24 is coupled to base 22 at second fluid-discharge aperture 52 as shown, for example, in FIG. 5. Pour spout 24 is configured to define second discharge-port means for discharging fluid material 98 extant in interior region 32 of fluid-storage body 30 by tipping container 12 about tipping axis 100 in clockwise direction 250 after removal of removable cap 14 from filler neck 34 without discharging fluid material 98 from interior region 32 of fluid-storage body 30 through conduit passageway 66 and first fluid-discharge aperture 68 when no fluid-transfer tip 77 of syringe 28 is present in syringe receiver 26 as suggested in FIG. 4.

Base 22 includes a round plate 40 formed to include first and second fluid-discharge apertures 68, 52 and an annular side wall 42 as suggested in FIGS. 5 and 8. Annular side wall 42 extends upwardly from a perimeter edge of round plate 40 and cooperates with round plate 40 to form an upwardly opening basin 43 therein as suggested in FIG. 5. Syringe receiver 26 is coupled to round plate 40 and arranged to lie in basin 43 as suggested in FIGS. 1, 2, and 5.

Removable cap 14 includes a top wall 96 and a side wall 94 depending from top wall 96 as suggested in FIGS. 1 and 2. Filler neck 34 includes an interior wall 92 formed to define filler-neck passageway 38 as suggested in FIGS. 2 and 5 and arranged to mate with annular side wall 42 of base 22 and an exterior wall 90 configured to mate with side wall 42 of removable cap 14 when removable cap 14 is mounted on filler neck 34. Top wall 96 of removable cap 14 is arranged to lie in spaced-apart relation to round plate 40 of base 22 to locate syringe receiver 26 in a space provided between round plate 40 of base 22 and top wall 90 of removable cap 14 when removable cap 14 is mounted on filler neck 34.

Syringe receiver 26 is defined by an upstanding tubular sleeve 70 formed to include a sleeve passageway 74 as shown, for example, in FIG. 5. Syringe receiver 26 is coupled at a lower end thereof to round plate 40 to cause sleeve passageway 74 to communicate with first fluid-discharge aperture 68. Upstanding tubular sleeve 70 also includes an opposite upper end formed to include a mouth 72 opening into sleeve passageway 74 and facing toward top wall 96 of removable cap 14 when removable cap 14 is mounted on filler neck 34. Sleeve passageway 74 has an internal diameter that is greater than an internal diameter of first fluid-discharge aperture 68 as suggested in FIG. 5.

Pour spout 24 includes an outflow tube 50 coupled to round plate 40 at and in alignment with second fluid-discharge aperture 52 as suggested in FIG. 5. Outflow tube 50 is arranged to extend upwardly in basin 43 away from fluid-storage body 30 of container 12. Outflow tube 50 of pour spout 24 and syringe receiver 26 lie in spaced-apart relation to one another in basin 43 and to annular side wall 42 of base 22. Syringe receiver 26 is defined by an upstanding sleeve 70 coupled to round plate 40. Syringe receiver 26 is formed to include a sleeve passageway 74 communicating with first fluid-discharge aperture 68 and to terminate at an upper end formed to include a mouth 72 opening into sleeve passageway 74 and arranged to lie in spaced-apart relation to round plate 40 to define a first distance between the upper end of upstanding sleeve 70 and round plate 40. Outflow tube 50 of pour spout 24 is formed to include a tube passageway 88 communicating with second fluid-discharge aperture 52 as suggested in FIG. 5. Outflow tube 50 is configured to terminate at an upper end formed to include a mouth opening into tube passageway 88 and arranged to lie in spaced-apart relation to round plate 40 to cause at least a portion 80 of the upper end of outflow tube 50 defines a greater second distance between the at least a portion 80 of the upper end of outflow tube 50 and round plate 40.

Upstanding tubular sleeve 70 is arranged to lie in filler-neck passageway 38 as suggested in FIGS. 1 and 5. Fluid-transfer conduit 20 is arranged to extend upwardly into filler-neck passageway 50 to mate with base 22 at first fluid-discharge aperture 68 as suggested in FIG. 5.

Base 22 includes a round plate 40 arranged to occlude filler-neck passageway 38 and characterized by a first diameter D1 as suggested in FIG. 10. Round plate 40 is formed to include first and second fluid-discharge apertures 68, 52. First fluid-discharge aperture 68 is characterized by a second diameter D2 that is about 15% of first diameter D1 as suggested in FIGS. 5 and 10. Second fluid-discharge aperture 52 is characterized by a third diameter D3 that is about 45% of first diameter D1 as suggested in FIGS. 5 and 10.

Syringe receiver 26 is defined by an upstanding sleeve 70 having an annular inner wall defining a sleeve passageway 74 communicating with first fluid-discharge aperture 68. Base 22 includes an annular inner wall defining first fluid-discharge aperture 68 as suggested in FIG. 5. An internal diameter of the annular inner wall of upstanding sleeve 70 is greater than an internal diameter of the annular inner wall of round plate 40. Fluid-transfer conduit 20 has an annular inner wall defining conduit passageway 66 and having an internal diameter that is about equal to the internal diameter of the annular inner wall of base 22.

Pour spout 24 is arranged to lie above a portion of fluid-transfer conduit 20 located in interior region 32 of fluid-storage body 30 as suggested in FIGS. 6 and 7. Fluid-transfer conduit 20 is curved and configured to include a concave surface 84 arranged to face upwardly toward pour spout 24 as suggested in FIGS. 6 and 7. Pour spout 24 includes an outflow tube 50 coupled to a top side of plate 40 at second fluid-discharge aperture 52 and arranged to extend away from concave surface 84 of fluid-transfer conduit 20 and an intake tube 48 coupled to an opposite underside of plate 40 at second fluid-discharge aperture 52 and arranged to extend toward concave surface 84 of fluid-transfer conduit 20 as suggested in FIGS. 6 and 7.

Syringe receiver 26 is coupled to base 22 at first fluid-discharge aperture 68 as suggested in FIG. 5. Syringe receiver 26 is configured to define first discharge-port means for receiving a fluid-transfer tip 77 of a syringe 28 to allow flow of fluid material 98 from interior region 32 of fluid-storage body 30 into syringe 28 through first fluid-discharge aperture 68 in response to tipping of container 12 about a tipping axis 100 in a counterclockwise direction 150 after removal of removable cap 14 from filler neck 34 without discharging fluid material 98 from interior region 32 of fluid-storage body 30 through second fluid-discharge aperture 52 and pour spout 24 as suggested in FIG. 12.

Pour spout 24 is coupled to base 22 at second fluid-discharge aperture 52. Pour spout 24 is configured to define second discharge-port means for discharging fluid material 98 extant in interior region 32 of fluid-storage body 30 by tipping container 12 about tipping axis 100 in an opposite clockwise direction 250 after removal of removable cap 14 from filler neck 34 without discharging fluid material 98 from interior region 32 of fluid-storage body 30 through first fluid-discharge aperture 68 when no fluid-transfer tip 77 of syringe 28 is present in syringe receiver 26 as suggested in FIG. 4.

1. A package comprising
a container including a fluid-storage body formed to include an interior region and a filler neck having a mouth opening into a filler-neck passageway formed in the filler neck and arranged to communicate with the interior region of the fluid-storage body,
a removable cap configured to mount on the filler neck to close the mouth of the filler neck, and
a fluid dispenser including a closure coupled to the filler neck and arranged to communicate with and close the filler-neck passageway and a fluid-transfer conduit arranged to extend from the closure into the interior region of the fluid-storage body to communicate with fluid material stored therein, wherein the closure includes a base, a pour spout, and a syringe receiver, the base is arranged to mate with the filler neck to close the mouth opening into the filler-neck passageway and formed to include separate first and second fluid-discharge apertures, the fluid-transfer conduit is formed to include a conduit passageway and is coupled to the base at the first fluid-discharge aperture to place the conduit passageway in fluid communication with the first fluid-discharge aperture, the syringe receiver is coupled to the base at the first fluid-discharge aperture and configured to define first discharge-port means for receiving a fluid-transfer tip of a syringe to allow flow of fluid material from the interior region of the fluid-storage body into the syringe through the conduit passageway and through the first fluid-discharge aperture, and the pour spout is coupled to the base at the second fluid-discharge aperture and configured to define second discharge-port means for discharging fluid material extant in the interior region of the fluid-storage body by tipping the container after removal of the removable cap from the filler neck without discharging fluid material from the interior region of the fluid-storage body through the conduit passageway and the first fluid-discharge aperture when no fluid-transfer tip of a syringe is present in the syringe receiver.

2. The package of claim 1, wherein the base includes a round plate formed to include the first and second fluid-discharge apertures and an annular side wall extending upwardly from a perimeter edge of the round plate and cooperating with the round plate to form an upwardly opening basin therein and the syringe receiver is coupled to the round plate and arranged to lie in the basin.

3. The package of claim 2, wherein the removable cap includes a top wall and a side wall depending from the top wall, the filler neck includes an interior wall formed to define the filler-neck passageway and arranged to mate with the annular side wall of the base and an exterior wall configured to mate with the side wall of the removable cap when the removable cap is mounted on the filler neck, and the top wall of the removable cap is arranged to lie in spaced-apart relation to the round plate of the base to locate the syringe receiver in a space provided between the round plate of the base and the top wall of the removable cap when the removable cap is mounted on the filler neck.

4. The package of claim 3, wherein the syringe receiver is defined by an upstanding tubular sleeve formed to include a sleeve passageway and coupled at a lower end thereof to the round plate to cause the sleeve passageway to communicate with first the fluid-discharge aperture and the upstanding tubular sleeve also includes an opposite upper end formed to include a mouth opening into the sleeve passageway and facing toward the top wall of the removable cap when the removable cap is mounted on the filler neck.

5. The package of claim 2, wherein the pour spout includes an outflow tube coupled to the round plate at and in alignment with the second fluid-discharge aperture and arranged to extend upwardly in the basin away from the fluid-storage body of the container.

6. The package of claim 5, wherein the outflow tube of the spout receiver and the syringe receiver lie in spaced-apart relation to one another in the basin and to the annular side wall of the base.

7. The package of claim 5, wherein the syringe receiver is defined by an upstanding sleeve coupled to the round plate and formed to include a sleeve passageway communicating with the first fluid-discharge aperture and to terminate at an upper end formed to include a mouth opening into the sleeve passageway and arranged to lie in spaced-apart relation to the round plate to define a first distance between the upper end of the upstanding sleeve and the round plate and the outflow tube of the pour spout is formed to include a tube passageway communicating with the second fluid-discharge aperture and configured to terminate at an upper end formed to include a mouth opening into the tube passageway and arranged to lie in spaced-apart relation to the round plate to cause at least a portion of the upper end of the outflow tube defines a greater second distance between the at least a portion of the upper end of the outflow tube and the round plate.

8. The package of claim 1, wherein the syringe receiver is defined by an upstanding tubular sleeve formed to include a sleeve passageway and coupled at a lower end thereof to the base to cause the sleeve passageway to communicate with the first fluid-discharge aperture and the upstanding tubular sleeve also includes an opposite upper end formed to include a mouth opening into the sleeve passageway and facing toward the top wall of the removable cap when the removable cap is mounted on the filler neck.

9. The package of claim 8, wherein the upstanding tubular sleeve is arranged to lie in the filler-neck passageway.

10. The package of claim 9, wherein the fluid-transfer conduit is arranged to extend upwardly into the filler-neck passageway to mate with the base at the first fluid-discharge aperture.

11. The package of claim 8, wherein the sleeve passageway has an internal diameter that is greater than an internal diameter of the first fluid-discharge aperture.

12. The package of claim 1, wherein the base includes a round plate arranged to occlude the filler-neck passageway and characterized by a first diameter, the round plate is formed to include the first and second fluid-discharge apertures, and the first fluid-discharge aperture is characterized by a second diameter that is about 15% of the first diameter.

13. The package of claim 12, wherein the second fluid-discharge aperture is characterized by a third diameter that is about 45% of the first diameter.

14. The package of claim 1, wherein the syringe receiver is defined by an upstanding sleeve having an annular inner wall defining a sleeve passageway communicating with the first fluid-discharge aperture, the base includes an annular inner wall defining the first fluid-discharge aperture, and an internal diameter of the annular inner wall of the upstanding sleeve is greater than an internal diameter of the annular inner wall of the round plate.

15. The package of claim 14, wherein the fluid-transfer conduit has an annular inner wall defining the conduit passageway and having an internal diameter that is about equal to the internal diameter of the annular inner wall of the base.

16. The package of claim 1, wherein the pour spout is arranged to lie above a portion of the fluid-transfer conduit located in the interior region of the fluid-storage body and the fluid-transfer conduit is curved and configured to include a concave surface arranged to face upwardly toward the pour spout.

17. The package of claim 16, wherein the base includes a plate arranged to occlude the filler-neck passageway and formed to include the separate first and second fluid-discharge passageways and the pour spout includes an outflow tube coupled to a top side of the plate at the second fluid-discharge aperture and arranged to extend away from the concave surface of the fluid-transfer conduit and an intake tube coupled to an opposite underside of the plate at the second fluid-discharge aperture and arranged to extend toward the concave surface of the fluid-transfer conduit.

18. A package comprising
a container including a fluid-storage body formed to include an interior region and a filler neck having a mouth opening into a filler-neck passageway formed in the filler neck and arranged to communicate the interior region of the fluid-storage body,
a removable cap configured to mount on the filler neck to close the mouth of the filler neck, and
a fluid dispenser including a closure coupled to the filler neck and arranged to communicate with and close the filler-neck passageway, wherein the closure includes a base, a pour spout, and a syringe receiver, the base is arranged to mate with the filler neck to close the mouth opening into the filler-neck passageway and formed to include separate first and second fluid-discharge apertures, the syringe receiver is coupled to the base at the first fluid-discharge aperture and configured to define first discharge-port means for receiving a fluid-transfer tip of a syringe to allow flow of fluid material from the interior region of the fluid-storage body into the syringe through the first fluid-discharge aperture in response to tipping of the container about a tipping axis in a counterclockwise direction after removal of the removable cap from the filler neck without discharging fluid material from the interior region of the fluid-storage body through the second fluid-discharge aperture and the pour spout, and the pour spout is coupled to the base at the second fluid-discharge aperture and configured to define second discharge-port means for discharging fluid material extant in the interior region of the fluid-storage body by tipping the container about the tipping axis in an opposite clockwise direction after removal of the removable cap from the filler neck without discharging fluid material from the interior region of the fluid-storage body through the first fluid-discharge aperture when no fluid-transfer tip of a syringe is present in the syringe receiver.

19. The package of claim 18, wherein the base includes a plate arranged to occlude the filler-neck passageway and formed to include the separate first and second fluid-discharge passageways and the syringe receiver is coupled to the plate at the first fluid-discharge aperture and arranged to extend upwardly away from the fluid-storage body.

20. The package of claim 19, wherein the pour spout includes an outflow tube coupled to a top side of the plate at the second fluid-discharge aperture and arranged to extend away from the interior region of the fluid-storage body and arranged to lie in spaced-apart relation to the syringe receiver and the pour spout further includes an intake tube coupled to an opposite underside of the plate at the second fluid-discharge and arranged to extend toward the interior region of the fluid-storage body.

21. A package comprising
a fluid dispenser including a closure including a base adapted to mate with a container to occlude an opening into an interior region formed in the container and formed to include separate first and second fluid-discharge apertures, a syringe receiver coupled to the base at the first fluid-discharge aperture and configured to receive a fluid-transfer tip of a syringe to expose the fluid-transfer tip to fluid material extant in the interior region of the container via the first fluid-discharge aperture, and a pour spout coupled to the base at the second fluid-discharge aperture.

22. The package of claim 21, wherein the fluid dispenser further includes a fluid-transfer conduit coupled to the base at the first fluid-discharge aperture and configured to provide means for transferring fluid material through the first fluid-discharge aperture into a fluid-transfer tip of a syringe received in the syringe receiver in response to application of a suction force generated by the syringe to fluid material exposed to the fluid-transfer conduit.

23. The package of claim 22, wherein the fluid-transfer conduit is curved and configured to include a concave surface arranged to face upwardly toward the pour spout.
